(19) United States
(12) Patent Application Publication
(10) Pub. No.: US 2002/0075232 A1
(43) Pub. Date: Jun. 20, 2002

(54) Data glove

(76) Inventors: Wolfgang Daum, Schwerin (DE); Thomas Gunther, Schwerin (DE); Jorn Husert, Steinhagen (DE); Patrick Scherr, Schwerin (DE)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/015,909

(22) Filed: Dec. 10, 2001

Related U.S. Application Data
(63) Continuation of application No. 08/912,029, filed on Aug. 15, 1997.

(51) Int. Cl. G09G 5/08

(52) U.S. Cl. 345/158

(57) ABSTRACT

A sensor material for fabricating instrumented clothing includes conductive rubber layer. Two electrodes are disposed within the rubber layer, are connectable to an external circuit and are separated by a separation distance to form an electrical path from one electrode to the other through an intermediate portion of the conducting rubber layer. The electrical resistance measured between the electrodes is indicative of strain in the intermediate portion of the conducting rubber layer, thus permitting measurements of movement of the fabric to be made. The fabric may be used to form articles that a user can wear, including a data glove, so that movements of the user may be detected and measured.

### BACKGROUND OF THE INVENTION

The present invention is directed generally to an apparatus and method for detecting motion of parts of a body and more particularly to a lightweight instrumented fabric and its use

A data glove is generally a glove that fits over at least a part of a user's hand and detects movement of the user's fingers and/or thumb. Data gloves are commonly used for controlling computer games and in robotics, including medical robotics. Data gloves may also be used for motion capturing. For example, motion capturing is used in the capturing in the entertainment industry when the motions of a number of points on a hand are recorded in a computer, and the recorded motions then transferred to an animated hand in order to impart a greater sense of reality to the animation.

Data gloves have been implemented using several different approaches, including mechanical rods and linkages attached to the glove's joints to detect movement thereof. However, conventional data gloves suffer from several problems. First, they can be mechanically unstable, i.e. the sensors within the gloves that detect the movements of the fingers change their local position when the fingers move. Consequently, the sensitivity of the sensors to movement of the fingers changes, and the results may not be repeatable.

Second, conventional data gloves can be awkward for the user to operate because the sensors used in the glove for detecting finger movement also obstruct the movements of the hands and fingers. Therefore, the range of motion which can be measured can be limited, thus reducing the utility of the glove.

Third, the sensors employed in conventional data gloves can be complex, and not amenable to production by efficient industrial methods. Consequently, the fabrication of the sensors is expensive and the cost of the data glove is thereby increased.

Last, the glove may be uncomfortable for the user. Often the glove is made of a heavy rubber and there is a build up of sweat inside the glove. Also, as a result of the weight of the glove and the sensors, the user may tire very quickly, and it is common for a user to have to take a rest from using the glove after only several minutes' use. Therefore, conventional gloves are not suitable for applications that require the glove to be used for over a prolonged time.

There is therefore a need to produce a data glove where the sensors are stable, where the sensors do not obstruct movement and contribute significant weight to the glove, and which are amenable to cost efficient production techniques. There is also a need to produce a glove which is light in weight, comfortable to wear and which can be used for a prolonged duration.

### SUMMARY OF THE INVENTION

Generally, the present invention relates to a motion detector for detecting the movement of parts of a user's body. In one particular embodiment, the invention is directed to a sensor material for fabricating instrumented clothing, where the sensor material includes an electrically insulating rubber matrix layer with electrically conducting particles disposed within the rubber matrix layer to form a conducting rubber layer. Two electrodes are disposed within the rubber matrix layer, connectable to an external circuit and separated by a separation distance to form an electrical path from one electrode to the other through an intermediate portion of the conducting rubber layer. The electrical resistance measured between the electrodes is indicative of strain in the intermediate portion of the conducting rubber layer, thus permitting measurements of movement of the fabric to be made.

The fabric may be used to form articles that a user can wear. In another particular embodiment, the invention is directed to a data glove formed of flexible textile material, a portion of which has inner and outer layers. A layer of sensors is situated between the inner and outer textile layers.

An advantage of the invention is to permit a data glove to detect all finger movements of the human hand, where the glove can be manufactured using simple industrial processes, and which can be worn easily and comfortably by the user. Another advantage of the invention is that a data glove that gives reproducible measurements of hand and finger movements.

Another advantage of the invention is that sensors are positioned in a rubber matrix forming part of the article worn by the user, so that the sensors remain constantly in the same position relative to the user's body. Additionally, the article worn by the user may be formed to be lightweight and to permit normal perspiration from the body. Consequently, the user remains comfortable and does not tire quickly while wearing the article.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of the various embodiments of the invention in connection with the accompanying drawings, in which:

FIG. 1 illustrates a perspective view of a data glove according to one embodiment of the present invention;

FIG. 2 illustrates a sectional view through a rubber matrix portion of the data glove, showing conductive particles inserted within the matrix;

FIG. 3A illustrates a section through one embodiment of the data glove, showing a sensor system having a number of laminations through the glove;

FIG. 3B illustrates a section through a portion of another embodiment of the data glove showing electrodes embedded within a rubber matrix as sensors;

FIG. 4A illustrates a plot of voltage drop across a portion of sensor material plotted against stress in the sensor material;

FIG. 4B illustrates repeatability of a number of measurements as in FIG. 4A;

FIG. 5A illustrates a sensor stripe using helical electrodes;

FIG. 5B illustrates a data glove incorporating a number of sensor stripes of the form illustrated in FIG. 5A;

FIG. 6 illustrates an exploded view of different layers of one embodiment of the data glove;

FIG. 7 illustrates a system for acquiring, measuring and analyzing data produced by the data glove;

FIG. 8 illustrates the degrees of freedom of the hand that can be measured by a data glove;

FIG. 9 illustrates a block schematic diagram for data logger and transducer bank;

FIG. 10 illustrates a general view of a master-slave system incorporating the data glove;

FIGS. 11A to 11C illustrate various configurations for obtaining data from the data glove;

FIG. 12 illustrates a computer display screen for a computer game using gesture control from the data glove;

FIG. 13 illustrates a number of hand gestures detectable by the data glove; and

FIGS. 14A and 14B illustrate different presentations of logged data produced by the data glove.

While the invention is amenable to various modifications and alternative forms, specifics thereof have been shown by way of example in the drawings and will be described in detail. However, it should be understood that the intention is not to limit the invention to the particular embodiments described. On the contrary, the intention is to cover all modifications, equivalents, and alternatives falling within the spirit and scope of the invention and is defined by the appended claims.

### DETAILED DESCRIPTION OF THE PREFERRED EMBODIMENT

The present invention is directed to an instrumented fabric that can be formed into articles worn by a user to detect motion of various parts of the user's body While these articles worn by the user may take many different forms and be used to detect the motion of many different parts of the user's body, the description of the invention is directed to an embodiment of that includes a data glove in order to help the reader understand the full scope and applicability of the invention. The use of a data glove as an example is not intended to limit the scope of the invention, which is set out in the claims.

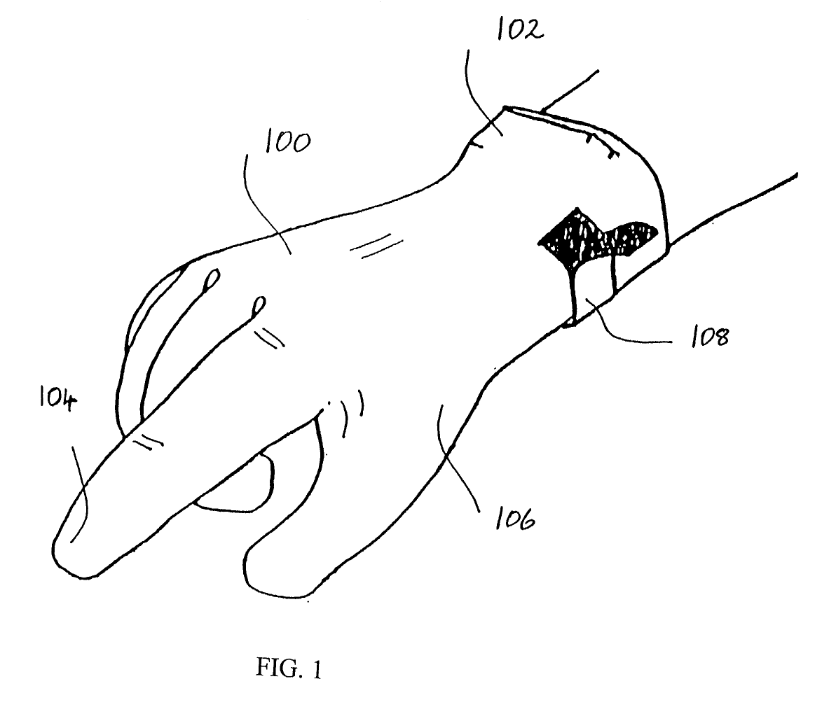

FIG. 1 illustrates a general view of a data glove. The data glove 100 is formed of a flexible material that fits to the human hand 106 like a normal glove. The flexible material may include a rubber layer. The rubber layer includes one or more sensors positioned strategically on the glove to detect various motions of the user's hand and digits, such as flexion of a finger joint. The rubber layer may extend partially or completely throughout the glove 100. The glove is provided with fingers 104 and a cable connection 102 so that data generated by the sensors may be transmitted to a signal analyzer. The glove 100 may also include a fastener 108 for holding the glove firmly in place on the user's hand 106. The fastener 108 may be of the hook and loop type, commonly known as VELCRO.

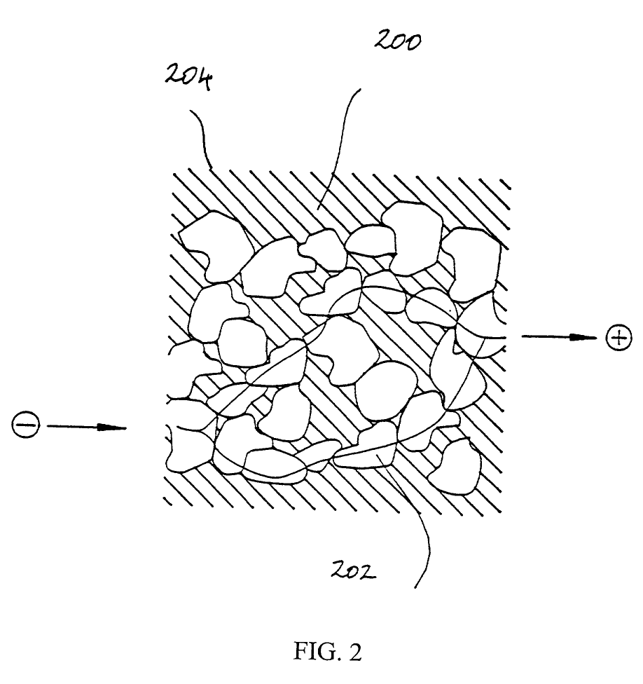

FIG. 2 illustrates a cross section through a portion of an electrically conductive rubber layer, such as may be used in the glove 100. The conductive rubber layer 204 includes a rubber matrix 200, which may be a conventional electrically insulating rubber, a liquid silicon rubber (formed by a vulcanization at high temperatures), or an RTV silicon rubber (room temperature vulcanized). As an example, Silopren 2530, manufactured by Beyer Corp. may be used for the rubber matrix 200.

Electrically conductive particles 202 are inserted in the rubber matrix 200. These particles 202 may be all be formed from the same material, or from different materials, and may have the same or different sizes. The electrically conductive particles may be, for example, carbon (graphite), titanium or aluminum or other metal particles. Additionally, the particles may be a mixture of, for example, carbon, titanium and graphite. The electrically conductive particles 202 may be surrounded with primers (bonding agents). The electrically conductive particles 202 are mixed into the liquid rubber before it is vulcanized to form the rubber matrix 200. The conductivity of the rubber layer 204 arises from the conductive particles 202.

As an example, an RTV silicon may be mixed with 5%-8% graphite powder. Preferably the fraction of graphite powder (e.g. Desire Vuntex L, or CA2) is 6%-7%, and more preferably the fraction of graphite powder is approximately 6.4%. 2%-3% of a vulcanization terminating agent (e.g. Beyer AC 3349) may also be added to maintain the flexibility of the silicone. The vulcanization terminating agent may be a cross-linking terminator or capper, or a chain terminator or capper.

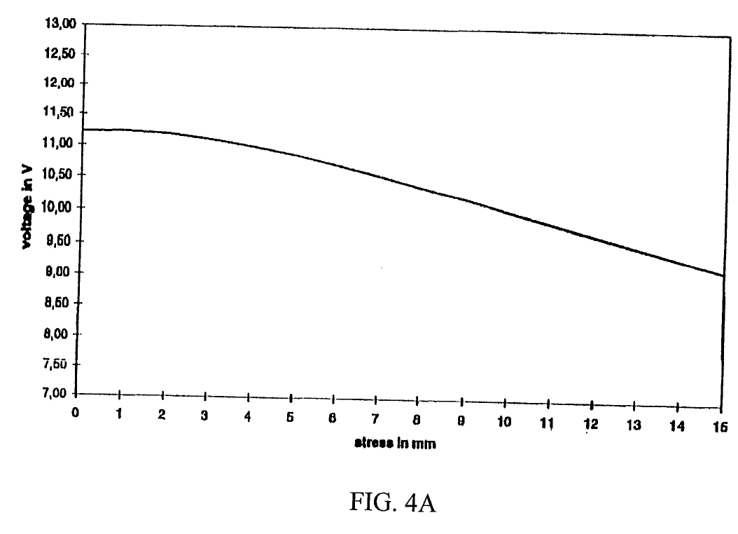

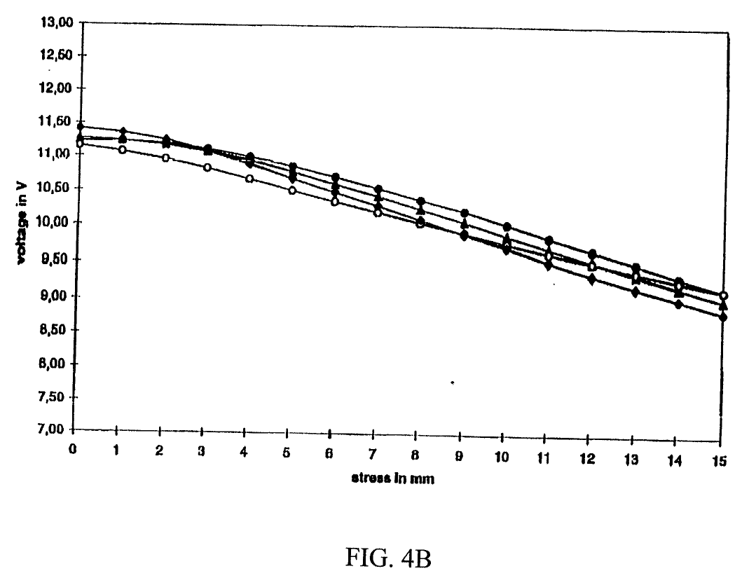

Rubber formed in this manner manifests an electrical resistivity that is dependent on the strain applied to the rubber matrix 200. This is illustrated in FIG. 4A, which shows the voltage drop measured across a sample of electrically conductive rubber as a function of strain from zero to 15 mm. FIG. 4B shows a similar plot of voltage drop against strain for the sample. The four curves represent different cycles in which the sample was strained: the voltage drop is plotted for each cycle to show the repeatability of the sensor's voltage drop. The unstretched rubber had a resistance of approximately 5 kΩ between electrodes separated by 2.5 cm.

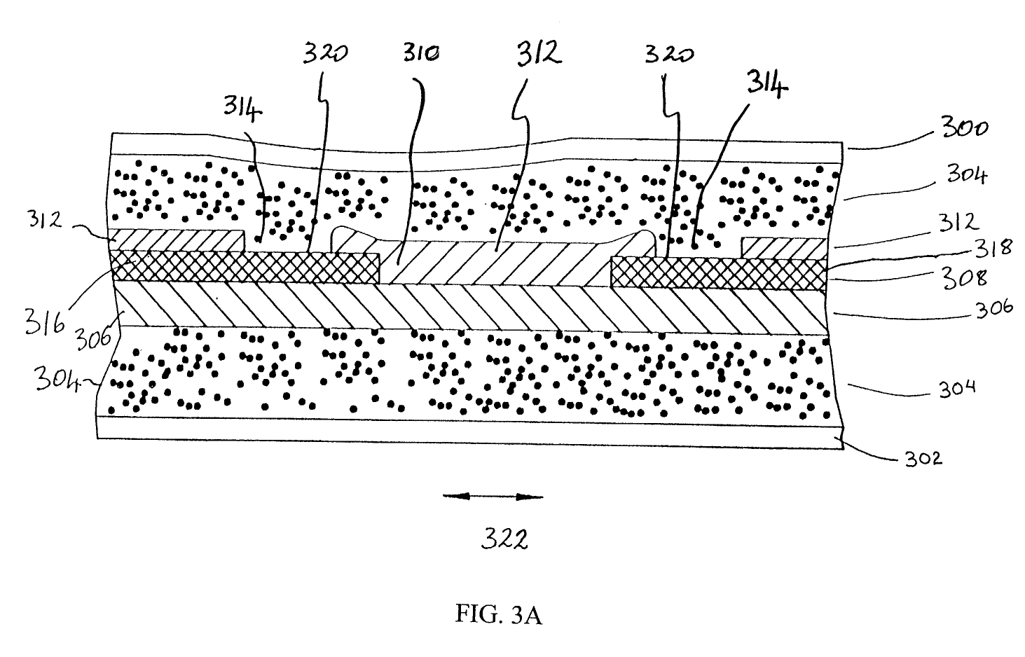

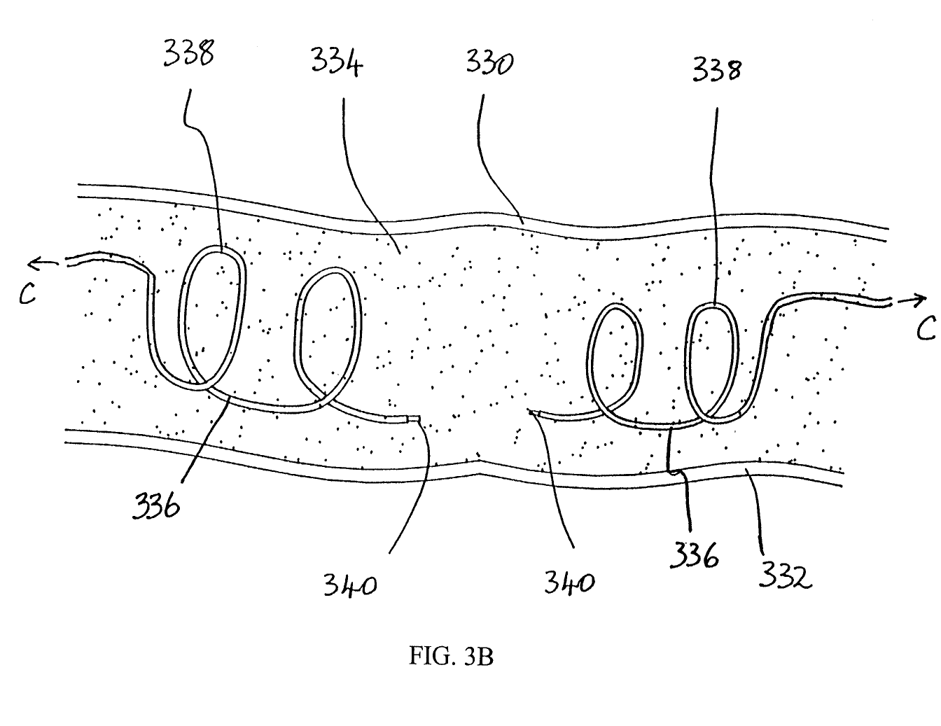

FIG. 3A illustrates a first embodiment of a sensor used in the glove 100 to detect motion of a digit. The figure illustrates a section through the material of the glove 100, between an outer isolating layer 300 and an inner isolating layer 302. The glove material includes two layers of electrically conductive rubber 304, separated by an isolation foil 306. A metallic foil 308 is provided on one side of the isolation foil 306. A gap 310 formed in the metal foil 308 is filled with another layer of insulation 312. A pair of insulation gaps 314 expose parts of the upper surface of the metallic film 308 to the conductive rubber 304. These exposed portions 320 of the metallic film 308 act as electrodes. The left portion of the metallic film 316 is electrically isolated from the right portion of the metallic film 318 except for the electrically conducting path from the electrodes 320 through the electrically conductive rubber 304. The metallic foil 308 is connected to a system (not illustrated) for measuring the resistance around an electrical circuit that includes the metallic film 308 and that portion of the electrically conductive rubber 304 lying between the electrodes 320. If the glove material is stretched in a lateral direction 322, for example by flexing of a finger, then the conduction path between the electrodes 320 changes, thus changing the electrical resistance measured. For example, if the length of the conduction path increases, e.g. through stretching the rubber, then the electrical resistance also increases. Conversely, if the length of conduction path is decreased, for example by compression of the rubber, then the resistance falls.

In another embodiment, illustrated in FIG. 3B, the glove material includes outer and inner insulating layers 330 and 332. A layer of electrically conducting rubber 334 is disposed between the outer and inner insulating layers 330 and 332. Helically wound, isolated wires 336, also called electrodes, are disposed within the electrically conductive rubber 334. Each electrode 336 includes a wire surrounded by a layer of insulation 338, and a bared metal tip 340. The electrodes 336 may be connected to an external circuit (labeled as “C”, not shown) so that current flows between the pair of bared metal tips 340 through the conducting rubber 304. The circuit may be included in a system for measuring electrical resistance. When the glove material is stretched or compressed, for example under flexion of knuckle, the distance separating the bared metal tips 340 changes, and there is a concomitant change in electrical resistance.

Although the electrodes 336 are not required to be helical, the helical shape is advantageous in allowing the electrodes 336 to bend and stretch with the rubber layer 334, while preventing the electrodes 336 from slipping from their positions within the layer 334. It will be appreciated that other arrangements may be used for ensuring that the relative movement between the electrodes 320 and 336 results from stretching the rubber layer 304 and 334, and does not arise from the electrodes slipping within the layer. For example, the end of the electrode 336 close to the metal tip 340 may be anchored in the rubber layer 334 using a collar or the like.

A rubber sensor layer having sensors disposed within the layer as illustrated in FIGS. 3a and 3b may be thin, for example 0.5 to 1 mm thick. Such a thin layer advantageously permits the glove to be flexible and reduces any limitations on the range of permissible glove movement. Also, such a thin layer reduces the weight of the data glove, thus allowing the user to operate the data glove for extended periods of time without undue fatigue.

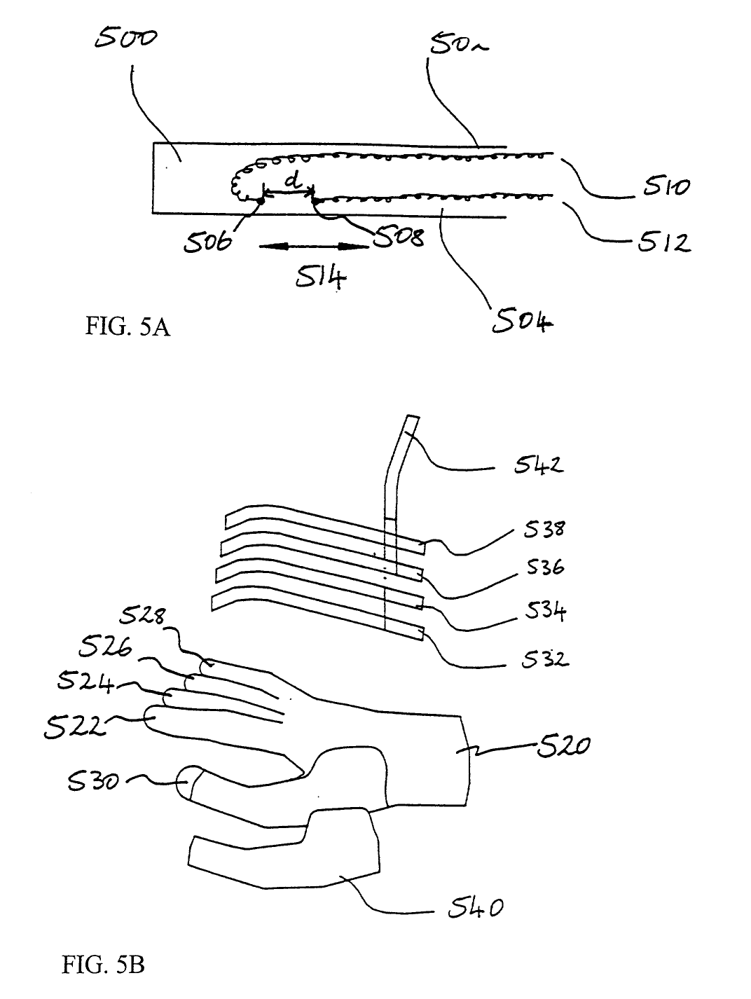

FIGS. 5A and 5B illustrate the application of a helical electrode type sensor to a glove. A sensor strip 500 is shown in FIG. 5A. The sensor strip includes two helical electrodes 502 and 504, having respective bared tips 506 and 508 separated by a distance d. The helical electrodes 502 and 504 are isolated from the environment by the outer and inner layers of the strip 500. A measurement of the electrical resistance across the end points 510 and 512 of the respective helical electrodes 502 and 504 provides a measure of the resistance, and therefore the distance, between the tips 506 and 508. Lateral stretching of the strip 500 in the direction 514 results in an increase in the measured resistance.

FIG. 5B illustrates the formation of a data glove by applying a number of sensor strips to an uninstrumented glove 520. The uninstrumented glove 520 includes four fingers 522, 524, 526, 528, and a thumb 530. Four sensor stripes 532, 534, 536 and 538 are applied to the back of the uninstrumented glove 520 and respective fingers 522, 524, 526, and 528 to produce an instrumented glove. Additionally, a thumb stripe 540 is applied on the back of the glove 520 and the thumb 530. To explain how the data glove works, consider that a user is wearing the glove 520. Flexion of the forefinger 522 results in a change in resistance measured in the respective forefinger stripe 532. This change in resistance may be detected by a control unit (not illustrated) and identified as a movement of the forefinger 522. Additionally, a transverse stripe 542 may be placed across the back of the glove 520 for detecting abduction, i.e. the spreading of the fingers 522, 524, 526, and 528 relative to one another.

It will be appreciated that each strip 532, 534, 536, 538, 540 and 542 may be provided with more than one sensor to detect motion at more than one position the glove 520. For example, the finger strips 532, 534, 536, and 538 may each be provided with three or more sensors, with at least one sensor being placed on a respective strip to sense the movement of a corresponding finger joint. Thus, the glove may be instrumented to detect motion of each joint, individually and independently. Additionally, the sensors may be disposed on individual strips attached to the glove, or may be disposed on a single layer attached to the glove.

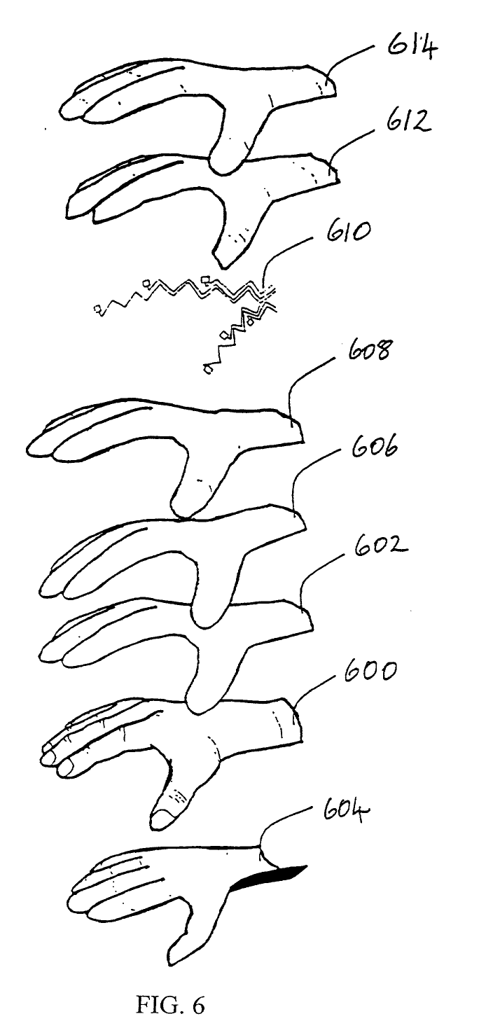

FIG. 6 illustrates another embodiment of a data glove. The hand 600 is surrounded by an inner glove portion having an upper portion 602 and a lower portion 604. The upper and lower portions 602 and 604 are illustrated to be separated, but it will be appreciated that the inner glove forms a single unit into which the user inserts his or her hand. A supporting layer 606 is disposed on the upper portion 602. A resistive rubber sensor layer 608 is disposed on the first isolating layer 606. A network of electrical cables 610 makes connections through the sensors in the sensor layer 608, and permits connection to a control unit (not illustrated). A second isolating layer 612 is disposed over the cable network 610. An outer layer 614 may be disposed on the second isolating layer 612. The outer layer may, for example, feature a design or the like indicative of the type of glove or the manufacturer thereof.

It will be appreciated that the sensor layer 608 may include a number of stripes having helically coiled electrodes, or may include laminated sensors as illustrated in FIG. 3A. It will further be appreciated that the sensor layer may be provided on either the dorsal (back) surface of the glove or the volar surface (the palm surface), or both. An advantage of placing the sensor layer on only one surface of the hand is that the other surface may breath through the fabric of the glove, thus increasing the user's comfort.

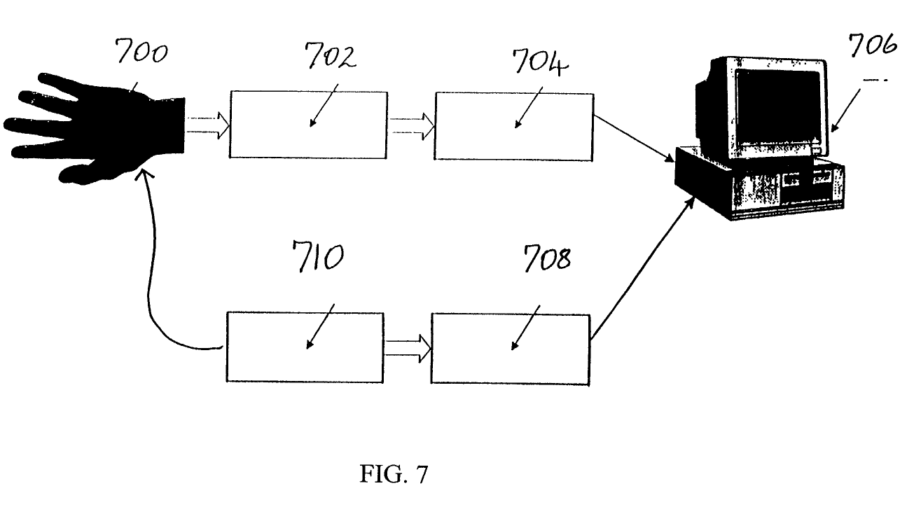

FIG. 7 illustrates one particular embodiment for recording and analyzing data produced by the data glove 700. Data from the data glove 700 are transmitted to a signal recording and conditioning unit 702. The recording and conditioning unit 702 receives resistance data from each of the sensors in the glove 700, and converts these signals into signals representative of the magnitude of extension detected by each sensor. These conditioned signals may then be directed through an interface 704 to a computer 706. The interface 704 may be, for example, an RS232 serial interface. It will be appreciated that the computer 706 may be a PC compatible type computer, Macintosh compatible computer, a UNIX based workstation, or any other type of computer.

The glove 700 may also be provided with a position sensor 710 which determines the position of the glove within a prescribed area, such as a room. A position sensor may be based on the detection of an electromagnetic or ultrasonic signal to determine position within the room. For example, an electromagnetically based sensor may have x, y, and z antennas for detecting x, y, and z, radiated signals. A measurement of the strength of the detected signals provides information on the distance from the transmitters. The position sensor 710 transmits position data through an interface 708 to the computer 706. The interface 708 may be, for example, an RS232 serial interface.

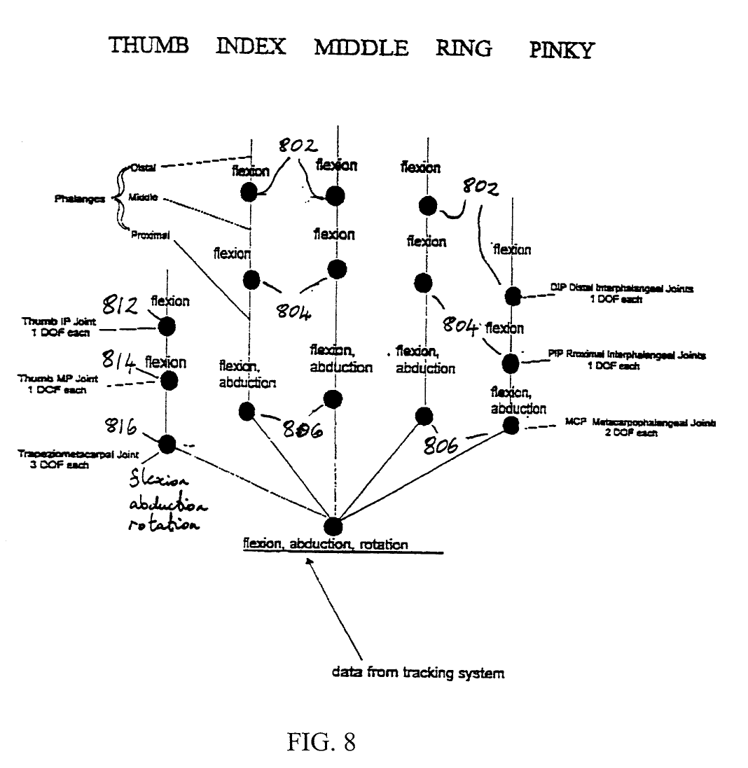

FIG. 8 illustrates the degrees of freedom (DOF) of the hand which may be measured using a data glove of the present invention. The figure illustrates four fingers, the index finger, the middle finger, the ring finger, and the pinkie finger, and the thumb. Black dots represent joints between adjacent finger bones. The dots marked 802 represent the joint between the distal phalanx and the middle phalanx of each finger (the distal interphalangeal joints). The dots marked 804 represent joints between the middle phalanx and the proximal phalanx of each finger (the proximal interphalangeal joints). The dots marked 806 represent the joints between the proximal phalanx and the metacarpal bone of each finger (the metacarpophalangeal joints).

The joint between the proximal phalanx and the distal phalanx of the thumb is marked 812 (the thumb interphalangeal joint), the joint between the proximal phalanx and the metacarpal bone of the thumb is marked as 814 (the thumb metacarpophalangeal joint), and the joint between the thumb metacarpal and the trapezium is marked as 816 (the trapeziometacarpal joint).

The data glove may provide a sensor for detecting flexion of the joint between the distal and middle phalanges of each finger, and also flexion of the joint between the middle and proximal phalanges of each finger. The numbers “1” indicate the number of types of movement detected at specification locations on the hand. Thus, where only flexion is measured, number “1” is shown.

The numbers “2” shown by the joints between the proximal phalanx and metacarpal of each finger 806 indicate that both flexion and abduction of these joints may be measured.

On the thumb, flexion may be measured on the joint between the distal and proximal phalanges 812, and the joint between the proximal phalanx and the metacarpal 814. However, since the thumb is opposable, there are three types of motion which may be measured at the joint between the metacarpal and the trapezium 816. These movements are flexion, abduction and rotation. Rotation is also known as opposition or circumduction.

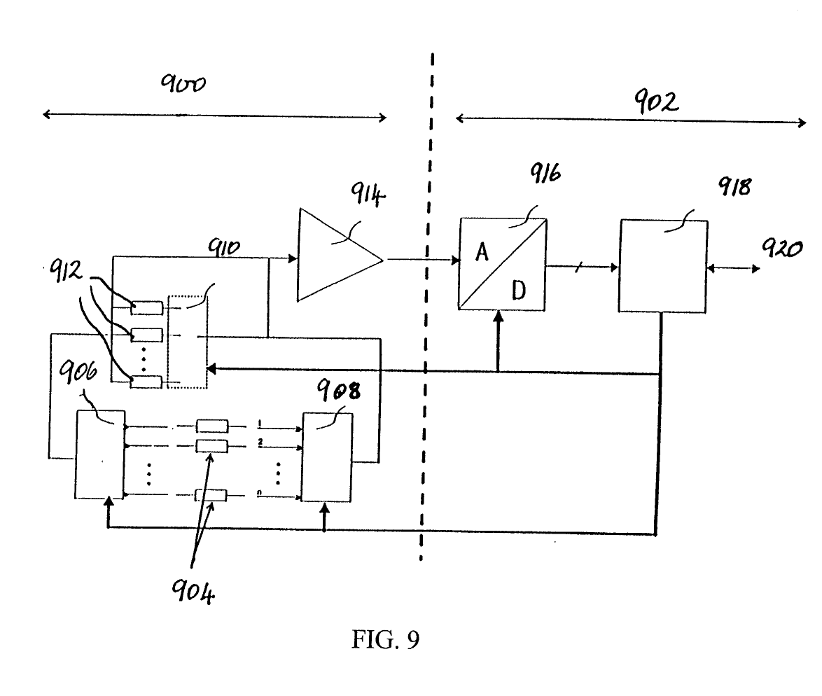

Data representing movements at all of these joints may be transmitted to a tracking system. An example of a circuit that may be used in signal acquisition, conditioning and analysis is illustrated in FIG. 9. Sensor resistance measurement functions are illustrated under the “signal conditioning” portion, labeled as 900. Signal analysis, including analog to digital conversion, and circuit control functions are illustrated under the “analyzer and control” portion, labeled 902.

The glove is assumed to have a number, n, of sensors 904. Each sensor 904 is connected to a demultiplexer 906 and a multiplexer 908. In one particular embodiment, the demultiplexer 906 and the multiplexer 908 are controlled by a processor 918 to selectively connect one of the sensors 904 with one of a number of measurement resistors 912. A programmable measurement resistor selector 910 is controlled by the processor 918. The voltage signal across the measurement resistor 912 is indicative of the resistance of the sensor selected by the demultiplexer 906 and multiplexer 908. The voltage signal is fed into an amplifier 914 before being converted to a digital signal in an analog-to-digital converter 916. The digitized signal is then transferred to the processor for further processing and analysis, or for transferring through an interface 920 to, for example, a computer.

The processor 918 controls the demultiplexer 906, the multiplexer 908 and the programmable measurement resistor selector 910 so as to sample the resistance of the sensors 904, or selected sensors 904, at regular intervals. When the sensor is strained over a large range, the voltage signal fed to the amplifier 914 increases. The processor 918 selects a measurement resistor 912 according to the amount of strain in the sensor 904 being measured, so that the voltage signal fed to the amplifier 914 remains within predetermined limits.

FIG. 10 illustrates a “master-slave” method of imaging the movements of a hand. The hand is contained within the data glove 1000, and data from sensors within the glove 1000 are conditioned in a signal conditioner 1002. The data from the signal conditioner 1002 are transmitted over a cable 1004 to an analyzer 1006. Analyzed data are then transmitted over an interface 1008 to a computer 1010. The computer 1010 is connected to a video monitor 1012. The computer 1010 may be configured to display an image of the hand 1014 that corresponds to the information transmitted from the glove 1000. Accordingly, the image of the hand 1014 may show movements that correspond to movements of the users hand within the glove 1000. It will be appreciated that the glove 100 may also act as a mast to control a robot hand operating as a slave. The robot hand may be connected to the data glove 1000 through a computer or other electronic circuit, so that the robot hand is controlled to produce movements corresponding to the movements detected by the data glove 1000.

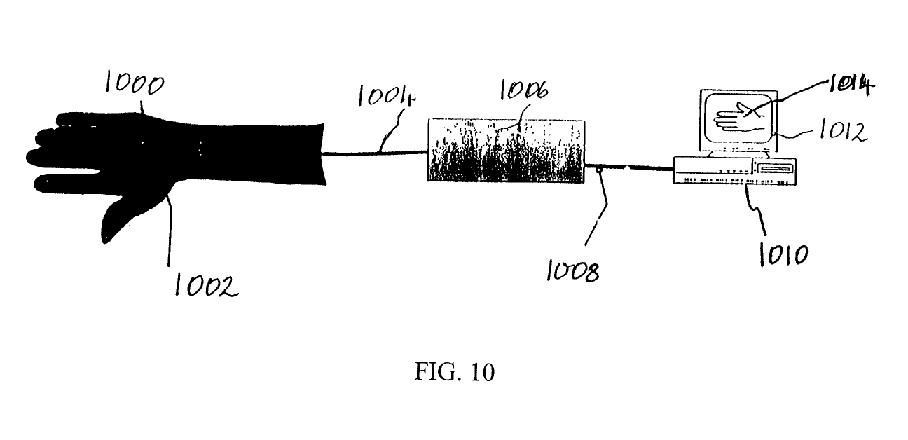

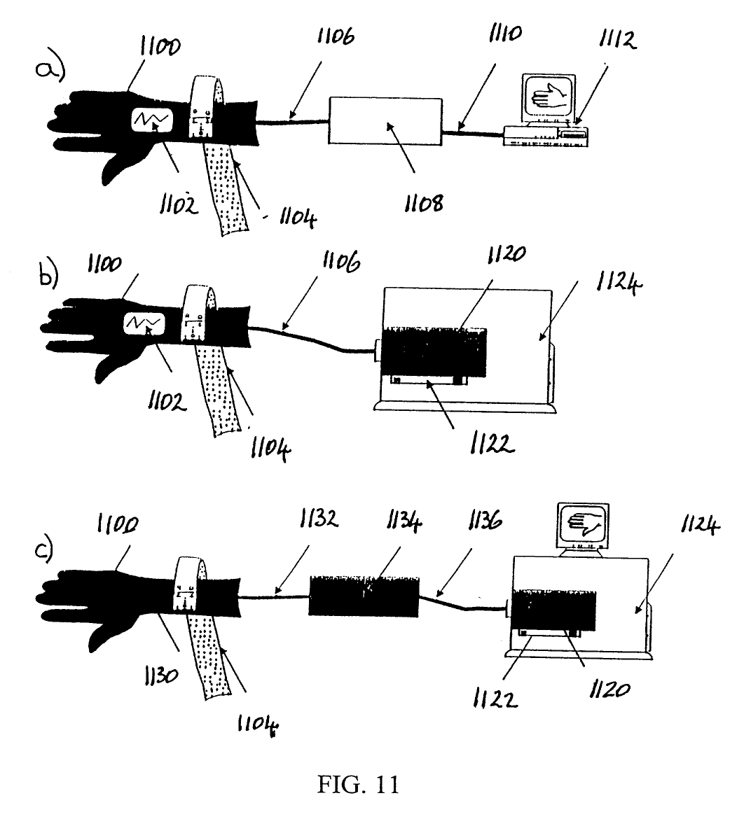

FIGS. 11a-11c illustrate different arrangements for connecting a data glove to a computer. In FIG. 11a, a data glove 1100 is provided with a signal conditioner 1102. The signal conditioner 1102 may be small and positioned on the back (dorsal) surface of the glove 1100 in a position where it causes little or no interference with the movements of the user's hand within the glove 1100. The glove may be provided with a strap 1104, fastener or the like to fit the glove 1100 tightly to the user's hand. A cable 1106 connects the signal conditioner 1102 to a signal analyzer 1108. The signal analyzer 1108 may include an analog-to-digital converter and a processor. The signal analyzer 1108 is connected through a second cable 1110 to a computer 1112, such as a PC, Macintosh, Unix workstation or the like.

Another arrangement for connecting the data glove 1100 to a computer is illustrated in FIG. 11b. Here, the computer 1124 includes an extension card 1122. The card 1122 includes a signal analyzer 1120 which is connected to the signal conditioner 1102 via the cable 1106.

In another arrangement for connecting the data glove 1100 to a computer, illustrated in FIG. 11c, the signal conditioner 1134 is removed from the glove 1100, and is connected thereto through a cable 1132 and connector 1130. The signal conditioner 1134 is connected via a second cable 1136 to the signal analyzer 1120 on the extension card 1122 within the computer 1124.

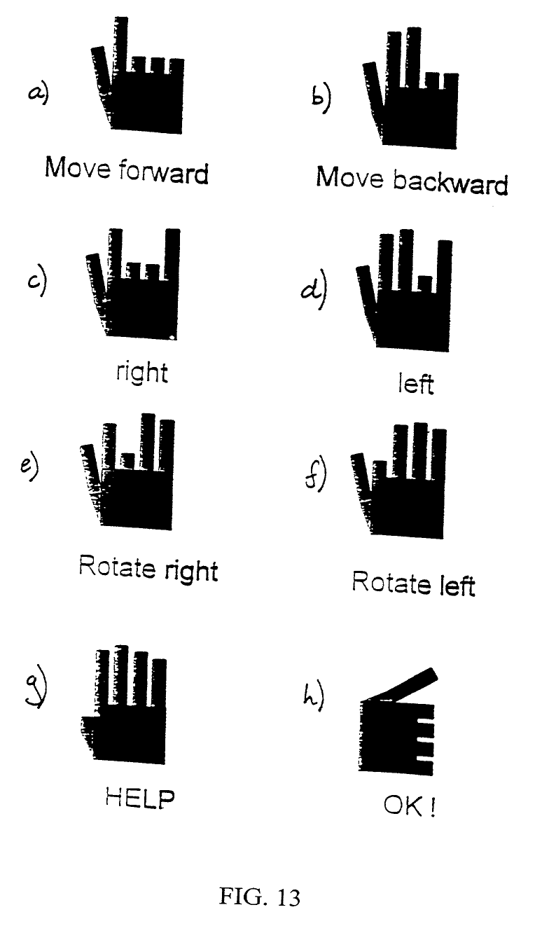

FIGS. 12 and 13 illustrate that the data glove may be used as an interface between a user and a computer for operating a computer game. FIG. 13 illustrates 8 different gestures that may be made by a hand inside a data glove. Each of these gestures may be associated with a particular instruction for a computer game. For example, a gesture in which the thumb and index finger are extending and the remaining fingers are folded may be used to represent an instruction to move forwards (gesture a)). A gesture in which the thumb and the index and middle fingers are extending may be used to represent an instruction to move backwards (gesture b)). A gesture in which the middle and ring fingers are folded and remaining fingers and thumb extending may be used to represent movement in one direction, for example, the right (gesture c)). A gesture in which all the fingers except the ring finger are extended, along with the thumb may represent an instruction to move to the left (gesture (d)). A gesture in which all fingers and the thumb are extended, except for the ring finger, may represent an instruction to rotate to the right (gesture e)). A gesture in which all fingers and the thumb are extended, except for the index finger, may represent an instruction to rotate to the left (gesture f)). A gesture in which all four fingers are extended and the thumb is folded may represent an instruction asking for help (gesture g)), and a gesture in which all fingers are folded and the thumb is extended may represent an “OK” command (gesture h).

It will be appreciated that various other gestures may be made by a hand wearing a data glove, and that these gestures may be used to represent additional commands. It will also be appreciated that the correlation between gestures and commands shown in FIG. 13 may be different.

Such a range of commands may be used to control a computer game such as is shown in FIG. 12, in which the user sees a screen 1200 which shows a virtual world having a number of different walls 1202 that create a virtual maze through which the user has to negotiate. A bar 1204 at the bottom of the screen illustrates a number of gestures associated with different commands. The bar 1204 on the lower edge of the screen 1200 may include a window 1206 that illustrates the current gesture detected from the glove. It will be appreciated that many computer games in which the user has to supply control commands to the computer may be controlled through the use of a number of gestures detected from a data glove.

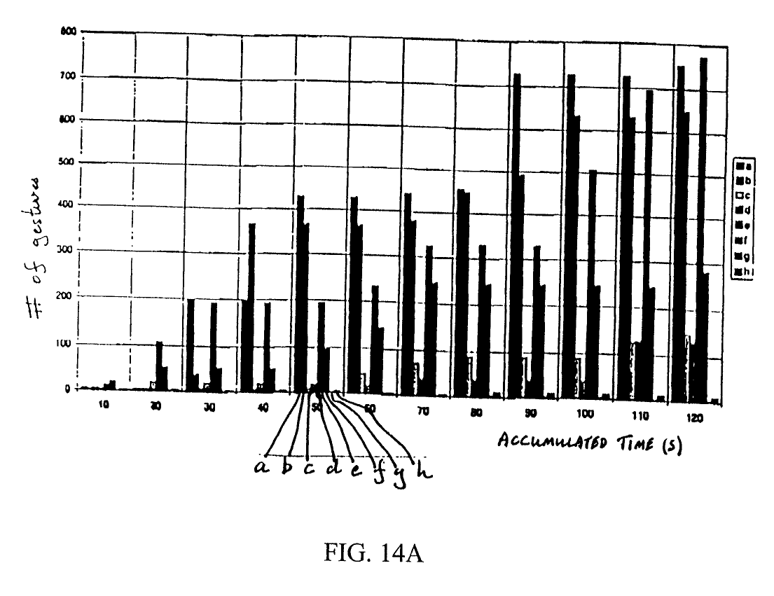

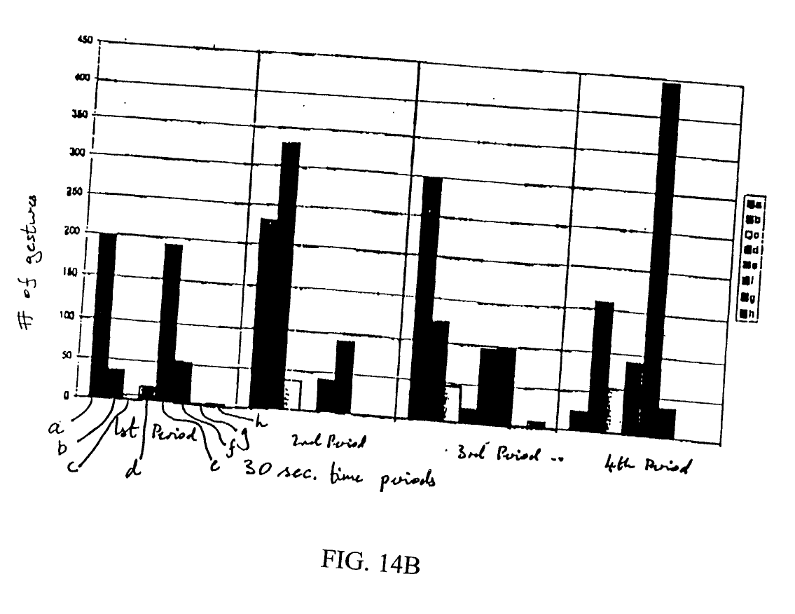

FIGS. 14A and 14B illustrate statistical analyses of a number of gestures performed by a user over a period of time. For each graph, a user repeatedly performed the gestures illustrated in FIG. 13. The individual gestures were logged by a computer and a tally of how many times the user performed each gesture was kept. FIG. 14A illustrates a cumulative total of the number of each type of gesture after 10, 20 30 etc. seconds. For example, after 50 seconds, the user had made approximately 425 gestures of type a), 370 gestures of type b) and less than 10 gestures of type c). After 90 seconds, the user had made gesture a) approximately 720 times, gesture b) approximately 490 times and gesture c) approximately 90 times. FIG. 14B illustrates the number of each type of gesture performed by the user in different 30 second intervals. For example, in the first interval of 30 seconds, the user performed 200 a) gestures and about 40 b) gestures, while in the second interval he performed about 230 a) gestures and about 330 b) gestures.

The information developed by the data glove and illustrated in FIGS. 14A and 14B may be useful for determining the physical performance of someone performing a critical task, such as an astronaut or a soldier. For example, a supervisor or supervising computer may monitor the movements of a particular individual performing a task. The different types of movements, or gestures, may be logged and compared to a reference dataset previously acquired for that individual, in which the individual's state of fatigue is correlated with the number of times different movements or gestures have been performed. Once the actual number of movements approaches a number previously determined to indicate that the individual is becoming fatigued, then the commander or controlling computer may indicate to the individual that it is time to rest. In illustration, it may have been previously determined in control experiments that the individual is able to perform no more than 350 gestures of type e) in a 30 second period without any significant fatigue occurring. However, in the fourth 30 second period shown in FIG. 14B, it is seen that the individual performs almost 450 e)-type gestures. Thus, the individual may be warned after the fourth 30 second period to take a rest because fatigue is likely to occur.

It will be appreciated that the motion of many different body parts may be detected and analyzed using sensors of the type disclosed herein. For example, rather than a glove, the user may wear a sleeve to detect movements of the elbow, or a shoulder harness to detect movements of the neck and shoulders. Sensors of this type may be fabricated to fit almost all of the moveable body parts, including but limited to fingers, hands, wrists, elbows, shoulders, neck, torso, hips, knees, ankles, feet and toes. It is also possible to combine sensors for different parts of the body. For example, a whole body sensor suit may monitor the movement of ankles, knees, hips, torso, shoulders, elbows and wrists, or may include sensors to monitor motion of another combination of body parts. Such a suit fits tightly over the selected body parts so that the sensors remain in place relative to the particular joints, limbs etc. that are to be monitored. For example, such a suit may be worn by an astronaut to allow mission control to monitor the astronaut's progress and movements during an exacting spacewalk mission. Comparison of the astronaut's movements with reference data taken from control experiments may indicate to doctors or mission control specialists when the astronaut is likely to become fatigued and, therefore, less effective.

While various examples were provided above, the present invention is not limited to the specifics of the examples. For example, the glove fitting around the hand may not be a full glove, but may have only partial fingers, for example extending from the hand to the second knuckle. The use of such a partial glove permits a user to sense movement of a reduced number of finger joints.

As noted above, the present invention is applicable to a glove for detecting motion of fingers and the thumb of a hand. While having use in many different applications, it is believed to be particularly useful for controlling computer games. Accordingly, the present invention should not be considered limited to the particular examples described, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A data glove for use with a user's hand, comprising:
a glove portion fittable on the user's hand, the glove portion having an inner layer portion;
a sensor layer integrally attached to an outer surface of the inner layer portion for movement therewith, the sensor layer including a strain sensor embedded within a conductive rubber matrix and including a metal foil having a first gap therein, the first gap filled with an insulating material, a first electrically insulating material contacting a first surface of the metal foil, a second electrically insulating material contacting a second surface of the metal foil, and the conductive rubber matrix contacting the second electrically insulating material, wherein the second electrically insulating material is formed with at least a second gap to expose portions of the second surface of the metal foil to the conductive rubber matrix to conduct an electrical current between the exposed portions of the metal foil through the conductive rubber matrix; and
an information port connected to the strain sensor, the information port being connectable to an external circuit.

2. A data glove according to claim 1, wherein the at least one stress sensor includes two insulated electrodes embedded within the conductive rubber matrix so as not to slip within the rubber matrix, the electrodes having mutually opposing bare wire ends separated within the rubber matrix by a preselected separation distance.

3. A data glove according to claim 1, wherein the at least one stress sensor includes a metal foil, the metal foil having a first gap therein, the first gap filled with an insulating material, a first electrically insulating material contacting a first surface of the metal foil, a second electrically insulating material contacting a second surface of the metal foil, and the conductive rubber matrix contacting the second electrically insulating material, wherein the second electrically insulating material is formed with at least a second gap to expose portions of the second surface of the metal foil to the conductive rubber matrix so that an electrical current is flowable between the exposed portions of the metal foil through the conductive rubber matrix.

4. A data glove according to claim 1, wherein the sensor layer includes a sensor strip provided on a finger of the glove portion having the at least one sensor to detect flexion of the glove finger.

5. A data glove according to claim 1, wherein the sensor layer includes a sensor strip provided across a back portion of the glove portion to detect abduction of a glove finger.

6. A data glove according to claim 1, wherein the sensor layer is provided at least partially on a posterior surface of the glove portion.

7. A data glove according to claim 1, wherein the sensor layer is provided at least partially on a volar surface of the glove portion.

8. A data glove according to claim 1, wherein the sensor layer includes sensors to sense flexion of first, second, and third knuckles of a user's finger, and abduction of the user's finger.

9. A data glove according to claim 1, wherein the sensor layer includes sensors to sense flexion, abduction, and rotation of the user's thumb.

10. A data glove according to claim 1, further comprising a computer connected to the information port to analyze sensor data produced by the at least one sensor.

11. A data glove according to claim 10, wherein the computer further includes a monitor adapted to display an image of a hand under control of the computer, and the computer controls the image of the hand to move in a manner corresponding to movements of the user's hand detected by the sensor layer.

12. A data glove according to claim 10, wherein the computer is configured to recognize gestures made by the user's hand in the data glove and to interpret the gestures as computer commands.

13. A data glove according to claim 12, wherein the computer is operable to run a computer game and the gestures recognized by the computer include commands to direct the computer game.

14. A data glove according to claim 1, wherein the electrical connector is connected to a signal conditioning unit to produce a conditioned signal corresponding to a strain signal received from the at least one sensor.

15. A data glove according to claim 14, further comprising a signal analyzer, including an analog-to-digital converter, and a computer, wherein the conditioned signal is received by the signal analyzer to produce a digitized signal in response to the conditioned signal, and the computer receives the conditioned signal.

16. A data glove according to claim 1, further comprising a position sensor movable with the glove portion so as to determine position of the user's hand within a defined space.

17. A sensor material for fabricating instrumented clothing, comprising:
a rubber matrix layer impregnated with electrically conducting particles to form a conducting rubber layer, the conducting rubber layer:
first and second insulating outer layers disposed on respective first and second surfaces of the conducting rubber layer; and
two metal electrodes disposed within the rubber matrix layer, connectable to an external circuit and separated by a separation distance to form an electrical path from one electrode to the other through an intermediate portion of the conducting rubber layer;
wherein the electrical resistance measured between the electrodes is indicative of strain of the intermediate portion of the conducting rubber layer.

18. A sensor material according to claim 17, wherein each electrode comprises an insulated metal wire having a bared metal tip, the bared metal tips being mutually opposed.

19. A sensor material according to claim 17, further comprising a metal foil, the metal foil disposed within the rubber matrix layer, connectable to an external circuit and having a first gap therein, the first gap being filled with a gap insulating material, a first electrically insulating material layer contacting a first surface of the metal foil, a second electrically insulating material layer contacting a second surface of the metal foil, and the conductive rubber matrix contacting the second electrically insulating material, wherein the second electrically insulating material has at least a second gap to expose portions of the second surface of the metal foil to the conductive rubber matrix, the exposed portions of metal foil forming the electrodes.

20. A sensor material according to claim 17, further comprising first and second insulating outer layers disposed on respective first and second outer surfaces of the conducting rubber layer.
